(19) United States
(12) Patent Application Publication
(10) Pub. No.: US 2026/0161945 A1
(43) Pub. Date: Jun. 11, 2026

(54) METHOD AND APPARATUS FOR MODIFYING ARCHITECTURE OF LARGE LANGUAGE MODEL

(71) Applicant: LG ELECTRONICS INC., Seoul (KR)

(72) Inventors: Wooseong CHUNG, San Jose, CA (US); Nilesh MALPEDDI, Fremont, CA (US); Jimmy GOU, San Jose, CA (US); Jacob SONG, Cupertino, CA (US); Bahattin YILDIZ, Milpitas, CA (US); Gabrielle DE MICHELI, San Diego, CA (US); Sanghyun BYUN, Los Angeles, CA (US)

(73) Assignee: LG ELECTRONICS INC., Seoul (KR)

(21) Appl. No.: 19/415,128

(22) Filed: Dec. 10, 2025

Related U.S. Application Data
(60) Provisional application No. 63/730,939, filed on Dec. 11, 2024.

(51) Int. Cl. G06N 3/082; G06N 3/0475

(52) U.S. Cl. CPC G06N 3/082; G06N 3/0475

(57) ABSTRACT

According to at least one embodiment, a computer-implemented method of modifying an architecture of a large language model (LLM) includes compressing an embedding layer of the LLM to reduce a size of a parameter space of the LLM, wherein the embedding layer has an embedding dimension of n, wherein compressing the embedding layer includes utilizing a first intermediate mapping configured to map a token to an m-dimensional vector, and wherein m is less than n. The method further includes compressing a plurality of transformer layers of the LLM to further reduce the size of the parameter space of the LLM.

### CROSS-REFERENCE TO RELATED APPLICATION(S)

This application claims the benefit of earlier filing date of Provisional Application No. 63/730,939, filed on Dec. 11, 2024, the contents of which are hereby incorporated by reference herein in their entirety.

### BACKGROUND

Transformers are used in artificial intelligence (AI) models to process sequential or structured data—such as text, code, images, or audio—while capturing long-range dependencies. In the context of transformer architectures, the phrase parameter space refers to all the trainable weights and biases in the model. These are the numerical values the model learns during training to perform tasks such as language understanding, translation, or text generation.

AI models utilizing large transformer architectures may result in a parameter size averaging at 7 billion and reaching 70 billion. Such a large number of parameters in turn provides generalized, multi-expert large language models (LLM) s that can provide better assistance and context-rich information to their users.

### SUMMARY

However, large numbers of such parameters present a challenge for edge deployment of such models, as memory and computation resources are constrained

Aspects of this disclosure leverage embedding layer compression, tensor decomposition, low-rank decomposition, and adaptive transformer block pruning to compress transformer architectures used, e.g., for modern deep learning models such as LLMs. Through a multi-stage approach, the pipeline achieves an average of greater than 10 times compression while preserving accuracy of state-of-the-art models.

Aspects of this disclosure are directed to compressing model architectures by decomposing weight tensors and swapping transformer layers (e.g., minimal-impact transformer layers) with a small adapter. By retraining a model architecture to its specific downstream task in a much smaller parameter space (e.g., retaining an LLM to operate with a smaller number of parameters such that accuracy can be regained), an even higher compression ratio can be reached.

According to one or more aspects, this is achieved through moving the problem to a smaller parameter space, thus avoiding underdetermination of the task and enabling joint optimization that converges toward a solution that addresses the task. When the parameter space is large in view of a task that is sufficiently specific, underdetermination of the task may occur. Aspects of this disclosure are directed to achieving an improved ratio between the size of the parameter space and the size of the task design space (or choice selection space).

According to at least one embodiment, a computer-implemented method of modifying an architecture of a large language model (LLM) includes compressing an embedding layer of the LLM to reduce a size of a parameter space of the LLM, wherein the embedding layer has an embedding dimension of n, wherein compressing the embedding layer includes utilizing a first intermediate mapping configured to map a token to an m-dimensional vector, and wherein m is less than n. The method further includes compressing a plurality of transformer layers of the LLM to further reduce the size of the parameter space of the LLM.

According to at least one embodiment, an artificial intelligence (AI) device is configured to modify an architecture of a large language model (LLM). The AI device includes: at least one transceiver; and at least one processor. The at least one processor is configured to: compress an embedding layer of the LLM to reduce a size of a parameter space of the LLM, the embedding layer having an embedding dimension of n, by utilizing a first intermediate mapping configured to map a token to an m-dimensional vector, wherein m is less than n; and compress a plurality of transformer layers of the LLM to further reduce the size of the parameter space of the LLM.

According to at least one embodiment, a non-transitory storage medium stores instructions that, when executed, cause at least one processor to perform operations. The operations include: compressing an embedding layer of a large language model (LLM) to reduce a size of a parameter space of the LLM, wherein the embedding layer has an embedding dimension of n, wherein compressing the embedding layer comprises utilizing a first intermediate mapping configured to map a token to an m-dimensional vector, and wherein m is less than n; and compressing a plurality of transformer layers of the LLM to further reduce the size of the parameter space of the LLM.

### BRIEF DESCRIPTION OF THE DRAWINGS

The accompanying drawings, which are included to provide a further understanding of the disclosure, illustrate embodiments of the disclosure and together with the description serve to explain aspects of the disclosure:

FIG. 1 illustrates a block diagram of a large language model (LLM) architecture according to at least one embodiment;

FIG. 2 illustrates a block diagram of an artificial intelligence (AI) server according to at least one embodiment;

FIG. 3(a) illustrates a restructured form of embedding learning according to at least one embodiment;

FIG. 3(b) illustrates a simplified example of a linear function that involves matrices of two dimensions;

FIG. 4 illustrates an example computation of the compression ratio achieved by the restructuring of FIG. 3(a);

FIG. 5 illustrates a representation of an application of tensor train decomposition to matrices in the composed embeddings;

FIG. 6 illustrates an example computation of the compression ratio, as further improved by utilizing tensor train decomposition;

FIG. 7 illustrates an example factorization of a tensor having a shape of n₁× n₂× n₃;

FIG. 8 illustrates an example factorization of a tensor having a shape of n₁× n₂;

FIG. 9 illustrates an example utilization of matrix-by-matrix training of 3 decomposed tensor cores;

FIG. 10 illustrates an example utilization of segment-by-segment training of 3 decomposed tensor cores;

FIG. 11(a) illustrates a block diagram of a transformer layer according to at least one embodiment;

FIG. 11(b) illustrates a block diagram of a low-rank adaptation according to at least one embodiment; and

FIG. 12 illustrates a flowchart of a method 1200 of modifying an architecture of an LLM according to at least one embodiment.

### DETAILED DESCRIPTION

Hereinafter, specific embodiments of the present invention will be described in more detail with reference to drawings.

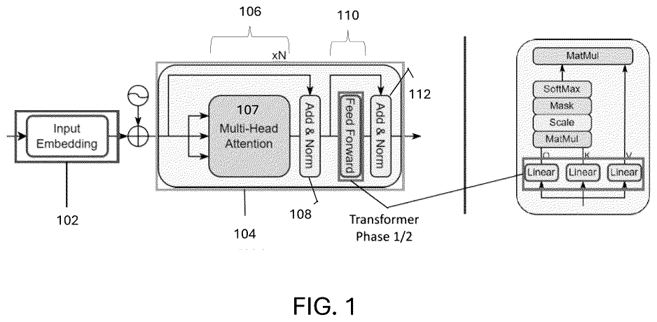

FIG. 1 illustrates a block diagram of a large language model (LLM) architecture according to at least one embodiment.

The LLM architecture is typically built around a transformer, which is a neural network design specialized for understanding and generating sequences such as text. Before text goes into the model, it is broken into tokens, which may be whole words, subwords, characters, or word pieces. Each of such tokens is mapped to an integer ID.

The token IDs are input to an embedding layer 102. At the embedding layer 102, token IDs are converted to continuous vectors (embeddings).

The output of an embedding layer learning is essentially a look-up table (LUT) of dimension n× V, where V denotes the size of the vocabulary considered and n denotes the embedding layer dimension. Each member (or word) of the vocabulary, i.e., each token, is represented as an n-dimensional vector. The size of the LUT also corresponds to the number of embedding parameters in the embedding layer 102.

In each continuous vector, two main types of embeddings may be added together: token embeddings and positional embeddings. Token embeddings represent the identity/meaning of tokens. Positional embeddings provide the model with information about word order.

With continuing reference to FIG. 1, the continuous vectors are output to a transformer layer (or transformer block) 104.

The transformer layer 104 may be considered as the core of the LLM. For purposes of simplicity, a single transformer layer 104 is illustrated in FIG. 1. However, it is understood that a typical LLM may have dozens or even hundreds of transformer layers that are stacked.

Each transformer layer 104 includes a self-attention mechanism 106 and a feed-forward network (FFN) 110.

Regarding the self-attention mechanism 106, every token looks at (or “attends to”) every other token in the sequence. The self-attention mechanism 106 computes contextual relationships and determines which parts of the text are relevant to each other. The computations involves trainable Q (query), K (key), and V (value) matrices. Query (Q) regards what a particular token is looking for, Key (K) regards what this token offers, and Value (V) regards the information carried. In case of dense, bidirectional attention, each token attends to all others, thereby giving a contextualized representation for each token.

Multi-head attention 107 is a core mechanism inside transformer models that allows the model to look at different parts of the input in multiple ways at the same time. Multi-head attention 107 is an extension of self-attention designed to increase the ability of the model to capture complex relationships.

Multi-head attention 107 may be considered as involving multiple self-attention layers in parallel. Instead of performing self-attention only once, the model performs it multiple times in parallel. Each “head” has its own learned Q, K, V projection matrices.

“Add & Norm” 108 refers to a pair of operations—Residual Addition and Layer Normalization—that are applied together after major sublayers such as multi-head attention and feed-forward networks. “Add & Norm” 108 keeps deep transformers stable, trainable, and efficient.

At “Add & Norm” 108, the transformer performs (after a sublayer such as self-attention mechanism 106): Add (Residual Connection) and then Norm (Layer Normalization). Add refers to a shortcut connection that preserves original information, helps gradients flow through deep networks, and prevents vanishing gradients. Norm rescales and recenters activations so they stay numerically stable during training.

Accordingly, the operations of “Add & Norm” 108 prevent information loss across layers, make extremely deep models possible, help the network to learn corrections rather than full transformations, and improve training stability.

At the FFN 110, a set of multi-layer perceptron (MLP) is applied independently to each token. This expands and contracts the hidden dimension to create a richer transformation.

The FFN 110 processes each token independently, transforming its hidden representation. Unlike attention (which mixes information across tokens), the FFN 110 applies the same neural network to every token.

Similar to “Add & Norm” 108, which is applied after multi-head attention 107, “Add & Norm” 112 is applied after the FFN 110. The operations of “Add & Norm” 112 are similar to those described earlier with reference to “Add & Norm” 108.

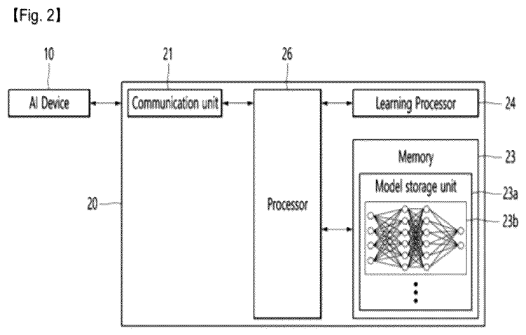

FIG. 2 illustrates a block diagram of an artificial intelligence (AI) server according to at least one embodiment.

FIG. 2 illustrates a block diagram of an AI server 20 according to at least one embodiment of the present disclosure. As illustrated in FIG. 2, the AI server 20 is connected to the AI device 10.

The AI server 20 may refer to a device that learns an artificial neural network (ANN) (e.g., the LLM of FIG. 1) by using a machine learning algorithm or uses a learned artificial neural network. The AI server 20 may include a plurality of servers to perform distributed processing, or may be defined as a 5G network. The AI server 20 may be included as a partial configuration of the AI device 10, and may perform at least part of the AI processing together.

The AI server 20 may include a communication interface 21, a memory 23, a learning processor 24, a processor 26, and the like.

The communication interface 21 can transmit and receive data to and from an external device such as the AI device 10.

The memory 23 may include a model storage unit 23a. The model storage unit 23a may store a learning or learned model (or an ANN 26b) through the learning processor 24.

The learning processor 24 may learn the ANN 26b by using the learning data. The learning model may be used in a state of being mounted on the AI server 20, or may be used in a state of being mounted on an external device such as the AI device 10.

The learning model may be implemented in hardware, software, or a combination of hardware and software. If all or part of the learning models are implemented in software, one or more instructions that constitute the learning model may be stored in memory 23.

The processor 26 may infer the result value for new input data by using the learning model and may generate a response or a control command based on the inferred result value.

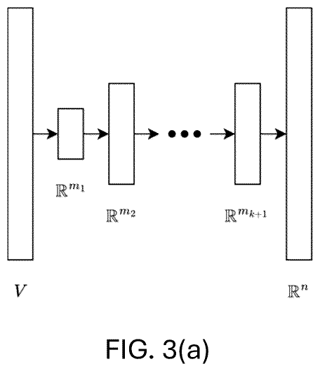

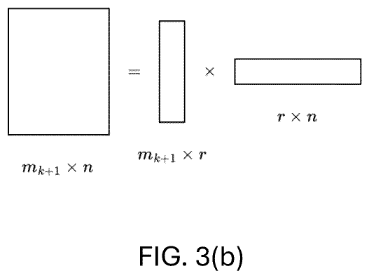

FIG. 3(a) illustrates a restructured form of embedding learning according to at least one embodiment. Such embedding learning may be performed at the embedding layer 102 of FIG. 1.

The embedding space is typically written as: [symbol] ⁿ where n denotes the embedding dimension (e.g., 768, 1024, 4096, etc.). Each token is mapped to a vector in this n-dimensional space.

According to aspects of this disclosure, embedding learning is restructured to reduce (or compress) the number of embedding parameters. The compression may use some function composition of well-chosen maps.

According to at least one embodiment, an intermediate mapping is used to allow for dealing with vectors of a smaller dimension when mapping the tokens. This smaller dimension, referred to herein as the width m, is smaller than the embedding dimension n. According to various embodiments, the width m is much smaller than then embedding dimension n. For example, according to at least one further embodiment, m is an integer less than or equal to 10. As another example, m is an integer less than or equal to 3 (e.g., m is equal to 3, 2 or 1).

According to at least one embodiment, an embedding map defined as the composition of two maps σ₁∘ σ₀ is used. The first map σ₀: M→ [symbol] ^{m} maps a token to an m-dimensional vector. As noted earlier, the width m may be much smaller than the embedding dimension n.

The second map σ₁: [symbol] ^{m}→ [symbol] ⁿ expands the m-dimensional vector back to the embedding dimension n. According to at least one embodiment, the second map is defined as the composition of a linear function h_{L} and non-linear functions h_{NLi} for i=1, 2, . . . , k. (Here, it is understood that the term function refers to a matrix and an activation function.) For example, the second map may be defined as σ₁=h_{L}∘h_{NLK}∘ . . . ∘h_{NL1}.

The non-linear functions (or maps) h_{NLi} may be defined as h_{NLi}: [symbol] ^{m}^{ᵢ}→ [symbol] ^{m}^{ᵢ₊₁} where x→ReLU (Wᵢ·x+bᵢ) with Wᵢ ∈ [symbol] ^{m}^{ᵢ}^{+1×m}^{ᵢ} and bᵢ ∈ [symbol] ^{m}^{ᵢ₊₁} Here, the value of m₁ is equal to the width m. Also, x denotes a vector in [symbol] ^{m}, W denotes a weight matrix, and b denotes a bias value.

In the context of LLMs, ReLU (Rectified Linear Unit) is a type of activation function used in the neural network, and is defined as ReLU (z)=max (0, z).

With reference to FIG. 3(a), the non-linear function h_{NL1} maps from [symbol] ^{m}^{₁}→ [symbol] ^{m}^{₂}. Similarly, the non-linear function h_{NL2} maps from [symbol] ^{m}^{₂}→ [symbol] ^{m}^{₃}, and so forth, with the non-linear function h_{NLk} mapping from [symbol] ^{m}^{ₖ}→ [symbol] ^{m}^{ₖ₊₁}.

The last function h_{L} is linear and corresponds to a weighted summation h_{L}: [symbol] ^{m}^{ₖ₊₁}→ [symbol] ⁿ, where x→W_{L}·x+b_{L} with W_{L} ∈ [symbol] ^{nxmk+1} and b_{L} ∈ [symbol] ⁿ.

FIG. 3(b) illustrates a simplified example of a linear function that involves matrices of two dimensions.

It is understood that various parameters can be fine-tuned and adjusted in the restructuring that has been disclosed. Such parameters include: the width m, the intermediate dimensions mᵢ, and also the number k of non-linear functions h_{NLi}.

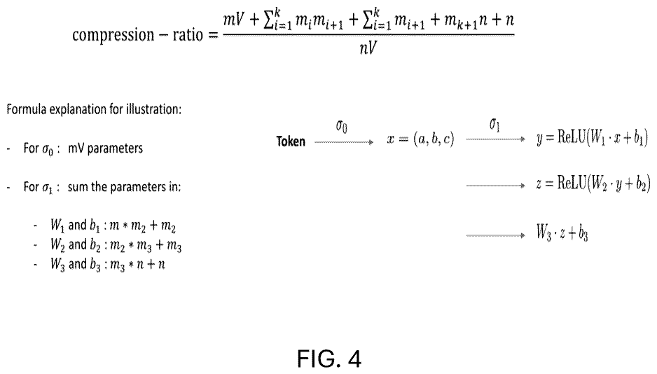

FIG. 4 illustrates an example computation of the compression ratio achieved by the restructuring of FIG. 3(a).

According to at least one embodiment, in addition to utilizing the composed embeddings of the disclosed restructuring, tensor train decomposition is utilized to further compress the embedding layer parameters. For example, tensor train decomposition may be applied to the larger (or largest) matrices of the embeddings. Such larger matrices may be the matrices of dimension n×mₖ₊₁. Here, tensor train decomposition may be applied to further improve compression ratio while still maintaining good accuracy.

At the embedding layer, tensor train decomposition factorizes a large matrix into a chain of smaller 3-D tensors or tensor train (TT) cores, such that E [i, j]≈G₁ [i₁]·G₂ [i₂]· . . . · G_{d}[i_{d}].

In this regard, the embedding index i is represented in a multi-index form across several modes. The embedding vector dimension j can also be factorized. TT-ranks control compression, whereby lower rank leads to more compression. Accordingly, a larger dense matrix can be replaced with a sequence of smaller tensors.

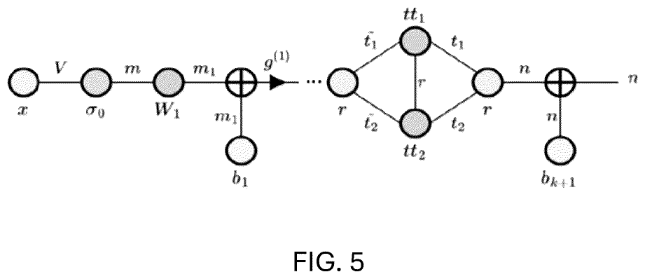

FIG. 5 illustrates a representation of an application of tensor train decomposition to matrices in the composed embeddings.

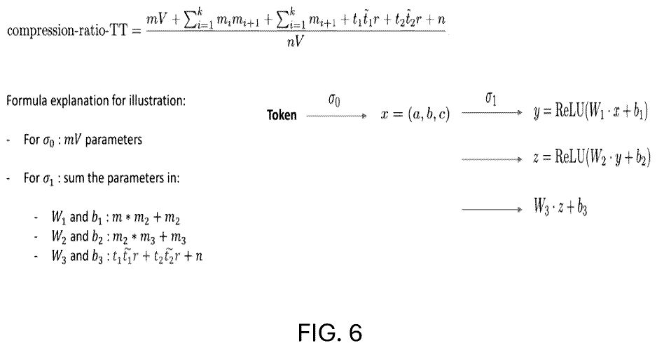

FIG. 6 illustrates an example computation of the compression ratio, as further improved (e.g., relative to the compression ratio of FIG. 4) by utilizing tensor train decomposition.

Compression of a transformer layer (e.g., transformer layer 104 of FIG. 1) will now be described with reference to various embodiments. According to at least one embodiment, compression of the transformer layer includes applying tensor train decomposition (or tensor decomposition) and performing transformer layer pruning. In combination, both processes serve to reduce the number of parameters according to the tasks presented.

When applied in the transformer layer, tensor train decomposition may be used to compress large weight matrices in the transformer layer. Factorization of a larger tensor T into a sequence of smaller 3-D tensors is described in more detail below.

Tensor-train decomposition with a tensor having a shape of n₁× . . . × n_{d} may be represented as T(i₁, i₂, . . . , i_{d})=G₁ (i₁)·G₂ (i₂) . . . . G_{d}(i_{d}) where Gₖ (iₖ) is a 3-dimensional tensor core having a shape of rₖ₋₁×nₖ×rₖ, and rₖ are called TT-ranks controlling the size of the computations.

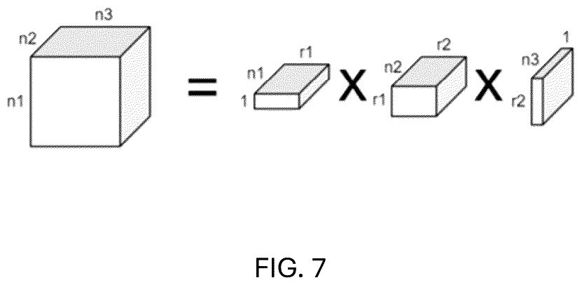

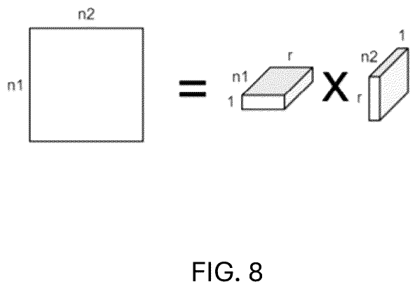

FIG. 7 illustrates an example factorization of a tensor having a shape of n₁×2×n₃. FIG. 8 illustrates an example factorization of a tensor having a shape of n₁×2.

It is understood that r₀=r_{d}=1 for the purpose of achieving scalar results Although a common technique for decomposition is sequential singular value decomposition (SVD), the compression of the transformer layer according to embodiments disclosed herein generates new tensors from scratch for re-training.

By way of example, the pipeline utilizes tensor-train decomposition on select weight matrices into 3 low-rank tensors in the manner described, producing T (i₁, i₂, i₃)=G₁ (i₁)·G₂ (i₂)·G₃ (i₃). For the purpose of similarity, TT-ranks may be set such that r₁=r₂. To re-train the decomposed tensor cores, either matrix-by-matrix training or segment-by-segment training may be utilized.

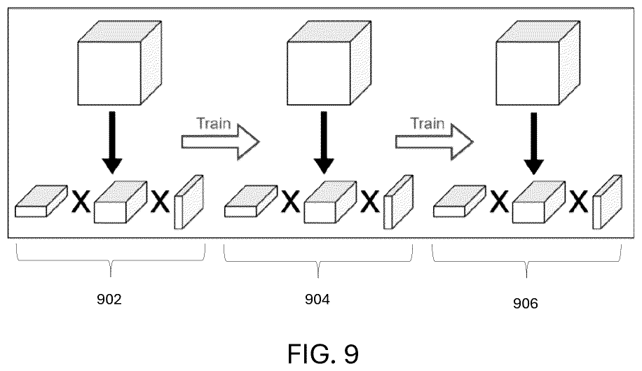

FIG. 9 illustrates an example utilization of matrix-by-matrix training of 3 decomposed tensor cores (decomposed tensor cores 902, 904 and 906). In this example, training epochs are run after updating each weight matrix to ensure consistent variation after decomposition. As the rest of the model's weights are kept frozen, this ensures that the decomposed weight can copy the function of the original tensor to the best of its ability.

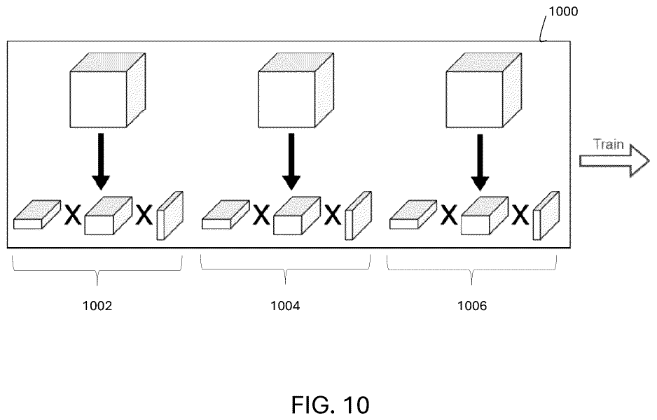

FIG. 10 illustrates an example utilization of segment-by-segment training of 3 decomposed tensor cores (decomposed tensor cores 1002, 1004 and 1006). Here, the term “segment” refers to a set of continuous transformer layers. Segment-by-segment training runs training epochs after updating all weight matrices in a transformer layer 1000, running the re-training pipeline after decomposition of the whole segment. Compared to matrix-by-matrix training, segment-by-segment training preserves the accuracy while requiring significantly fewer training epochs. This may make segment-by-segment training more desirable unless a significant variation shift or a decrease in accuracy from the loss of specialization of each layer is observed.

As noted earlier with reference to transformer layer compression, transformer layer pruning may be performed in addition to applying tensor train decomposition, to reduce the number of parameters according to the tasks presented. According to at least one embodiment, to better fit a large model to the dataset, one or more transformer layers that are deemed to be less impactful are adaptively replaced entirely with low-rank adaptation.

For example, each of one or more transformer layers is identified for replacement, based on a sensitivity of the transformer layer with respect to impact on performance of the LLM. The sensitivity may relate to impact on the overall accuracy and performance of the model if the transformer layer is replaced. If the transformer layer is deemed as being less sensitive than others transformer layers, then it may be identified for replacement.

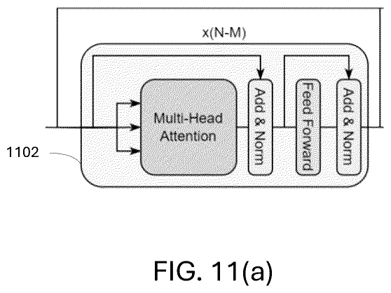

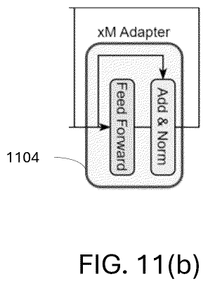

FIG. 11(a) illustrates a block diagram of a transformer layer 1102 that has been deemed to be less impactful. The transformer layer 1102 may be similar to the transformer layer 104 described earlier with reference to FIG. 1.

During transformer layer pruning, the transformer layer 1102 is replaced entirely with a low-rank adaptation 1104 of FIG. 11(b). According to at least one embodiment, the low-rank adaptation 1104 takes the form of gated MLP. Alternatively, the low-rank adaptation may take the form of a pair of low-rank matrices. To preserve the property of the transformer layer 1102, the same segment-by-segment training may be performed. Because the transformer layer 1102 has been entirely replaced by the low-rank adaptation 1104, matrix-by-matrix training is not considered.

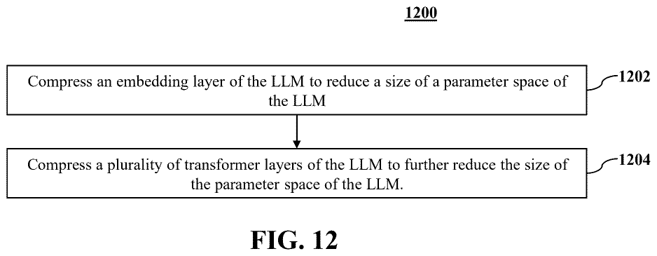

FIG. 12 illustrates a flowchart of a method 1200 of modifying an architecture of an LLM according to at least one embodiment.

At block 1202, an embedding layer of the LLM is compressed to reduce a size of a parameter space of the LLM. The embedding layer has an embedding dimension of n. Compressing the embedding layer (e.g., embedding layer 102 of FIG. 1) includes utilizing a first intermediate mapping configured to map a token to an m-dimensional vector, wherein m is less than n.

For example, as described earlier with reference to FIG. 3(a), an intermediate mapping is used to allow for dealing with vectors of a smaller dimension when mapping the tokens. The first map σ₀: M→ [symbol] ^{m} maps a token to an m-dimensional vector.

According to a further embodiment, m denotes an integer less than or equal to 10.

According to a further embodiment, m denotes an integer less than or equal to 3.

According to a further embodiment, compressing the embedding layer further includes utilizing a second intermediate mapping, the second intermediate mapping configured to map the m-dimensional vector to a n-dimensional vector. The second intermediate mapping may be based on a composition of a linear function and a plurality of non-linear functions.

For example, as described earlier with reference to FIG. 3(a), the second map σ₁: [symbol] ^{m}→ [symbol] ⁿ expands the m-dimensional vector back to the embedding dimension n. According to at least one embodiment, the second map is defined as the composition of a linear function h_{L} and non-linear functions h_{NLi} for i=1, 2, . . . , k. Accordingly, the second map is defined as σ₁=h_{L}∘h_{NLk}∘ . . . ∘h_{NL1}.

According to a further embodiment, compressing the embedding layer further includes applying tensor train decomposition to one or more larger matrices of the linear function and the plurality of non-linear functions.

For example, as illustrated in FIG. 5, tensor train decomposition is applied to matrices in the composed embeddings.

With reference back to FIG. 12, at block 1204, a plurality of transformer layers of the LLM is compressed to further reduce the size of the parameter space of the LLM.

According to a further embodiment, compressing the plurality of transformer layers includes performing tensor train decomposition and performing transformer layer pruning.

For example, as described earlier with reference to FIGS. 7, 8, 9, 10, 11(a) and 11(b), compression of the transformer layer includes applying tensor train decomposition (or tensor decomposition) and performing transformer layer pruning.

According to a further embodiment, performing the tensor decomposition generates new tensors for re-training based on matrix-by-matrix training (see, e.g., FIG. 9) or segment-by-segment training (see, e.g., FIG. 10).

According to a further embodiment, performing the transformer layer pruning includes replacing a transformer layer of the plurality of transformer layers with a coarse-granularity adapter. The coarse-granularity adapter may be based on a gated MLP or a pair of low-rank non-linear functions. Each of two or more of the plurality of transformer layers may be replaced with a respective coarse-granularity adapter.

For example, as described earlier with reference to FIGS. 11(a) and 11(b), during transformer layer pruning, the transformer layer 1102 of FIG. 11(a) is replaced entirely with a low-rank adaptation 1104 of FIG. 11(b).

According to a further embodiment, each of the two or more transformer layers is identified for replacement, based on a sensitivity of the transformer layer with respect to impact on performance of the LLM, scored by a set of common evaluation datasets. Examples of such datasets may include, but are not limited to, MMLU (Massive Multitask Language Understanding), Abstraction and Reasoning Corpus for Artificial General Intelligence (ARC-AGI) Evaluation, CommonSenseQA (CSQA), and WinoGrande.

Aspects and features described herein with reference to various embodiments are directed towards compressing the embedding layer and compressing the transformer layer, in combination, as a compression methodology. For example, after the embedding layer is compressed such that the size of the parameter space is reduced, the transformer layer is retrained in view of the specific task(s) to be addressed. As described earlier with reference to various embodiments, retraining may be performed via either matrix-by-matrix training or segment-by-segment training.

Embodiments disclosed herein allow flexibility in modifying model architecture at both the embedding-layer and transformer-layer levels by using different techniques and combining both coarse granular and fine granular building blocks. This improves control over model compression type, giving flexibility to prioritizing embedding size or attention module depending on the particular task(s) to be addressed. Also, disclosed embodiments are directed to achieving a higher compression ratio. Tensor decomposition allows for maximal compression as lower rank can be assigned for a higher compression ratio. Furthermore, as embedding layer contribution increases as the transformer layers are compressed, compression of the embedding layer boosts the compression ratio significantly. In addition, as disclosed earlier, replacement of one or more transformer layers is performed in view of the particular tasks to be addressed. Such fine-tuning is to ensure that the complexity of the task is correctly reflected in the number of layers used.

The above-described embodiments are combinations of the components and features of the disclosure in specific forms. Each component or feature should be considered optional unless explicitly mentioned otherwise. Each component or feature may be implemented without being combined with other elements or features. Furthermore, some components and/or features may be combined to implement embodiments of the disclosure. The order of operations described in the embodiments of the disclosure may be rearranged. Some components or features of one embodiment may be included in another embodiment, or the components or features may be replaced with related components or features of the other embodiment. It is obvious that claims that are not explicitly cited in the appended claims may be combined to form an embodiment or included as a new claim by amendment after filing. It is evident to those skilled in the art that the disclosure could be realized in various specific forms within the scope of the features of the disclosure. Therefore, the detailed description above should not be interpreted restrictively in all respects but should be considered as illustrative. The scope of the disclosure should be determined by a reasonable interpretation of the appended claims, and all changes within the equivalent scope of the disclosure are encompassed within the scope of the disclosure.

What is claimed is:

1. A computer-implemented method of modifying an architecture of a large language model (LLM), the computer-implemented method comprising:
compressing an embedding layer of the LLM to reduce a size of a parameter space of the LLM,
wherein the embedding layer has an embedding dimension of n,
wherein compressing the embedding layer comprises utilizing a first intermediate mapping configured to map a token to an m-dimensional vector, and
wherein m is less than n; and
compressing a plurality of transformer layers of the LLM to further reduce the size of the parameter space of the LLM.

2. The computer-implemented method of claim 1, wherein m denotes an integer less than or equal to 10.

3. The computer-implemented method of claim 1, wherein m denotes an integer less than or equal to 3.

4. The computer-implemented method of claim 1, wherein compressing the embedding layer further comprises utilizing a second intermediate mapping, the second intermediate mapping configured to map the m-dimensional vector to a n-dimensional vector.

5. The computer-implemented method of claim 4, wherein the second intermediate mapping is based on a composition of a linear function and a plurality of non-linear functions.

6. The computer-implemented method of claim 5, wherein compressing the embedding layer further comprises applying tensor train decomposition to one or more larger matrices of the linear function and the plurality of non-linear functions.

7. The computer-implemented method of claim 1, wherein compressing the plurality of transformer layers comprises:
performing tensor train decomposition; and
performing transformer layer pruning.

8. The computer-implemented method of claim 7, wherein performing the tensor train decomposition generates new tensors for re-training based on matrix-by-matrix training or segment-by-segment training.

9. The computer-implemented method of claim 7, wherein performing the transformer layer pruning comprises replacing a transformer layer of the plurality of transformer layers with a coarse-granularity adapter.

10. The computer-implemented method of claim 9, wherein the coarse-granularity adapter is based on a gated multilayer perceptron (MLP) or a pair of low-rank non-linear functions.

11. The computer-implemented method of claim 9, wherein each of two or more of the plurality of transformer layers is replaced with a respective coarse-granularity adapter.

12. The computer-implemented method of claim 11, wherein each of the two or more of the plurality of transformer layers is identified for replacement, based on a sensitivity of the transformer layer with respect to impact on performance of the LLM, scored by a set of common evaluation datasets.

13. An artificial intelligence (AI) device configured to modify an architecture of a large language model (LLM), the AI device comprising:
at least one transceiver; and
at least one processor configured to:
compress an embedding layer of the LLM to reduce a size of a parameter space of the LLM, the embedding layer having an embedding dimension of n, by utilizing a first intermediate mapping configured to map a token to an m-dimensional vector,
wherein m is less than n; and
compress a plurality of transformer layers of the LLM to further reduce the size of the parameter space of the LLM.

14. The AI device of claim 13, wherein m denotes an integer less than or equal to 10.

15. The AI device of claim 13, wherein m denotes an integer less than or equal to 3.

16. The AI device of claim 13, wherein the at least one processor is further configured to compress the embedding layer by utilizing a second intermediate mapping, the second intermediate mapping configured to map the m-dimensional vector to a n-dimensional vector.

17. The AI device of claim 13, wherein the at least one processor is further configured to compress the plurality of transformer layers by:
performing tensor train decomposition; and
performing transformer layer pruning.

18. The AI device of claim 17, wherein performing the tensor train decomposition generates new tensors for re-training based on matrix-by-matrix training or segment-by-segment training.

19. The AI device of claim 17, wherein performing the transformer layer pruning comprises replacing a transformer layer of the plurality of transformer layers with a coarse-granularity adapter.

20. A non-transitory storage medium storing instructions that, when executed, cause at least one processor to perform operations, the operations comprising
compressing an embedding layer of a large language model (LLM) to reduce a size of a parameter space of the LLM,
wherein the embedding layer has an embedding dimension of n,
wherein compressing the embedding layer comprises utilizing a first intermediate mapping configured to map a token to an m-dimensional vector, and
wherein m is less than n; and
compressing a plurality of transformer layers of the LLM to further reduce the size of the parameter space of the LLM.
